(19) United States
(12) Patent Application Publication
(10) Pub. No.: US 2022/0065161 A1
(43) Pub. Date: Mar. 3, 2022

(54) LIQUID NATURAL GAS PROCESSING WITH HYDROGEN PRODUCTION

(71) Applicant: ND Global Solutions, LLC, Houston, TX (US)

(72) Inventors: Ivan Van der Walt, Conroe, TX (US); Ben Heichelbech, Houston, TX (US); Alex Thompson, Sugar Land, TX (US); Vikrum Subra, Houston, TX (US); Victor Fernandes, Katy, TX (US); Michael Abegg, Anchorage, AK (US)

(21) Appl. No.: 17/094,518

(22) Filed: Nov. 10, 2020

Related U.S. Application Data
(63) Continuation of application No. 17/003,567, filed on Aug. 26, 2020.

(51) Int. Cl. F02C 3/20; F17C 9/02; F25J 1/00

(52) U.S. Cl. CPC F02C 3/20; F17C 9/02; F25J 1/0022; F25J 2230/22; F17C 2227/0157; F17C 2221/013; F25J 2215/10; F25J 2220/66; F17C 2270/0155; F17C 2270/0102; F17C 2221/033

(57) ABSTRACT

Devices, systems, and methods for liquefied natural gas production facilities are disclosed herein. A liquefied natural gas (LNG) production facility includes a liquefaction unit, a gas turbine, and a hydrogen generation unit. The liquefaction unit condenses natural gas vapor into liquefied natural gas. The hydrogen generation unit generates hydrogen. At least a portion of the hydrogen formed in the hydrogen generation unit is combusted, along with hydrocarbons, as fuel in the gas turbine.

### PRIORITY CLAIM AND CROSS-REFERENCE TO RELATED APPLICATIONS

This application is a continuation of U.S. patent application Ser. No. 17/003,567, filed Aug. 26, 2020, entitled LIQUID NATURAL GAS PROCESSING WITH HYDROGEN PRODUCTION, the entire contents of which are incorporated by reference herein and relied upon.

### BACKGROUND

Liquefied natural gas facilities are one type of energy facility that contribute to greenhouse gasses. Greenhouse gases comprise various gaseous compounds including, carbon dioxide, methane, nitrous oxide, hydrofluorocarbons, perfluorocarbons, and sulfur hexafluoride, that absorb radiation, trap heat in the atmosphere, and generally contribute to undesirable environmental greenhouse effects.

Liquefied natural gas facilities often implement certain forms of hydrocarbon emissions conversion technologies, such as thermal oxidizers and flares, to convert hydrocarbon emissions into carbon dioxide. Typically liquefied natural gas facilities do not incorporate greenhouse gas removal technologies. Sources of greenhouse gases in liquefied natural gas facilities typically include gas turbine exhaust(s), thermal oxidizers, various flares, and marine vent systems.

Liquefied natural gas production facilities, and related processes for producing liquefied natural gas in a facility, need to improve the overall efficiency of the facility and reduce greenhouse gas emissions.

### SUMMARY

In light of the disclosure herein, and without limiting the scope of the invention in any way, in a first aspect of the present disclosure, which may be combined with any other aspect listed herein unless specified otherwise, a liquefied natural gas (LNG) production facility includes a liquefaction unit, a gas turbine, and a hydrogen generation unit. The liquefaction unit condenses natural gas vapor into liquefied natural gas. At least a portion of hydrogen formed in the hydrogen generation unit is combusted, along with hydrocarbons, as fuel in the gas turbine.

In a second aspect of the present disclosure, which may be combined with any other aspect listed herein unless specified otherwise, the hydrogen generation unit comprises a steam reformer.

In a third aspect of the present disclosure, which may be combined with any other aspect listed herein unless specified otherwise, the LNG facility further comprises at least one post-combustion capture unit that generates a CO2-rich stream from the combustion products of the gas turbine.

In a fourth aspect of the present disclosure, which may be combined with any other aspect listed herein unless specified otherwise, the LNG facility further comprises at least one post-combustion capture unit that generates a CO2-rich stream from the products of the steam reformer.

In a fifth aspect of the present disclosure, which may be combined with any other aspect listed herein unless specified otherwise, the LNG facility further comprises a sequestration compression unit configured to compress and convey at least one CO2-rich stream from a post-combustion capture unit, towards a sequestration site, thereby reducing the overall emissions from the LNG facility.

In a sixth aspect of the present disclosure, which may be combined with any other aspect listed herein unless specified otherwise, the sequestration site comprises an underground geological formation comprising an at least partially depleted hydrocarbon reservoir.

In a seventh aspect of the present disclosure, which may be combined with any other aspect listed herein unless specified otherwise, the LNG facility further comprises an acid gas removal unit configured to accept raw feed natural gas and to generate an acid gas stream, a flash gas stream, and a purified natural gas stream, where the acid gas stream is directable to the sequestration compression unit.

In an eighth aspect of the present disclosure, which may be combined with any other aspect listed herein unless specified otherwise, the flash gas stream is directable to the sequestration compression unit.

In a ninth aspect of the present disclosure, which may be combined with any other aspect listed herein unless specified otherwise, the flash gas stream is directable to the steam reformer for use as a feedstock to the reformer.

In a tenth aspect of the present disclosure, which may be combined with any other aspect listed herein unless specified otherwise, the LNG facility further comprises a fuel gas conditioning unit configured to direct fuel gas to the gas turbine. The flash gas stream is directable to the fuel gas conditioning unit for use as fuel for the gas turbine.

In an eleventh aspect of the present disclosure, which may be combined with any other aspect listed herein unless specified otherwise, the sequestration compression unit comprises a compressor driven by steam from the steam reformer.

In a twelfth aspect of the present disclosure, which may be combined with any other aspect listed herein unless specified otherwise, the post-combustion capture unit includes an amine absorber and liquid amine absorbent for absorbing CO2. The steam reformer generates excess steam, and the excess steam is directable to the post-combustion capture unit to provide heat for regenerating the liquid amine absorbent.

In a thirteenth aspect of the present disclosure, which may be combined with any other aspect listed herein unless specified otherwise, the acid gas removal unit includes an amine absorber and liquid amine absorbent for absorbing CO2. The steam reformer generates excess steam, and where the excess steam is directable to the acid gas removal unit to provide heat for regenerating the liquid amine absorbent.

In a fourteenth aspect of the present disclosure, which may be combined with any other aspect listed herein unless specified otherwise, the LNG facility further comprises a dehydration unit including a solid adsorbent. The dehydration unit is configured to receive the purified natural gas stream from the acid gas removal unit and to provide a dry purified natural gas stream. The steam reformer generates excess steam, and the excess steam is directable to the dehydration unit to provide heat for regenerating the solid adsorbent.

In a fifteenth aspect of the present disclosure, which may be combined with any other aspect listed herein unless specified otherwise, the steam reformer generates excess steam, and the excess steam is directable to the sequestration unit. The sequestration compression unit comprises a compressor driven by the excess steam from the steam reformer.

In a sixteenth aspect of the present disclosure, which may be combined with any other aspect listed herein unless specified otherwise, the steam reformer generates excess steam, and the excess steam is directable to drive a compressor.

In a seventeenth aspect of the present disclosure, which may be combined with any other aspect listed herein unless specified otherwise, the sequestration compression unit comprises a compressor driven by an electric motor.

In an eighteenth aspect of the present disclosure, which may be combined with any other aspect listed herein unless specified otherwise, the sequestration compression unit comprises a compressor driven by a gas turbine.

In a nineteenth aspect of the present disclosure, which may be combined with any other aspect listed herein unless specified otherwise, the sequestration compression unit comprises a compressor driven by a hydrogen turbine configured to be driven by excess hydrogen from the steam reformer.

In a twentieth aspect of the present disclosure, which may be combined with any other aspect listed herein unless specified otherwise, the LNG facility further comprises a heavies removal unit, a condensation storage tank, an LNG storage tank, and an LNG loading facility. The heavies removal unit is configured to receive the dry purified natural gas stream from the dehydration unit and to produce a liquid condensate product and a vapor product. The condensation storage tank is configured to receive the liquid condensate product from the heavies removal unit, and to allow for the venting of boil off gas (BOG). The LNG storage tank is configured to receive and store LNG from the liquefaction unit, and allow for the venting of BOG. The LNG loading facility is configured to receive LNG from the LNG storage tank and to transfer LNG to a marine vessel comprising a marine LNG storage tank. The LNG loading facility is further configured to allow for the venting of BOG, where BOG from at least one of the condensation storage tank, the LNG storage tank, and the LNG loading facility is directable as feed to the steam reformer.

In a twenty-first aspect of the present disclosure, which may be combined with any other aspect listed herein unless specified otherwise, BOG from each of the condensation storage tank, the LNG storage tank, and the LNG loading facility is directable as feed to the steam reformer.

In a twenty-second aspect of the present disclosure, which may be combined with any other aspect listed herein unless specified otherwise, the LNG facility further comprises a marine vent system adapted to receive marine vessel tank gas from a marine LNG storage tank of a marine vessel, and to direct the marine vessel tank gas to feed any of a post-combustion capture unit, a sequestration compression unit, a fuel gas conditioning unit, and a steam reformer, where the marine vessel tank gas comprises BOG from LNG, CO, CO2, N2 or mixtures thereof.

In a twenty-third aspect of the present disclosure, which may be combined with any other aspect listed herein unless specified otherwise, fuel to the gas turbine contains at least about 10 percent hydrogen by volume.

In a twenty-fourth aspect of the present disclosure, which may be combined with any other aspect listed herein unless specified otherwise, fuel to the gas turbine contains about 60 to less than 100 percent hydrogen by volume.

In a twenty-fifth aspect of the present disclosure, which may be combined with any other aspect listed herein unless specified otherwise, fuel to the gas turbine contains about 75 to 85 percent hydrogen by volume.

In a twenty-sixth aspect of the present disclosure, which may be combined with any other aspect listed herein unless specified otherwise, a liquefied natural gas (LNG) production facility includes a liquefaction unit, a gas turbine, at least one post-combustion capture unit, and a sequestration compression unit. The liquefaction unit that condenses natural gas vapor into liquefied natural gas. The gas turbine is configured to combust a hydrocarbon fuel enriched with at least 10 percent hydrogen by volume. The at least one post-combustion capture unit generates a CO2-rich stream from the combustion products of the gas turbine. The sequestration compression unit configured to compress the CO2-rich stream from a post-combustion capture unit, and transport the CO2-rich stream towards an off-site sequestration reservoir, thereby reducing the overall emissions from the LNG facility.

In a twenty-seventh aspect of the present disclosure, which may be combined with any other aspect listed herein unless specified otherwise, the LNG facility further comprises an on-site hydrogen generation unit that provides hydrogen to the gas turbine.

In a twenty-eighth aspect of the present disclosure, which may be combined with any other aspect listed herein unless specified otherwise, the hydrogen generation unit is a methane gas reformer.

In a twenty-ninth aspect of the present disclosure, which may be combined with any other aspect listed herein unless specified otherwise, the LNG facility further comprises at least one post-combustion capture unit that generates a CO2-rich stream from the products of the steam reformer.

In a thirtieth aspect of the present disclosure, which may be combined with any other aspect listed herein unless specified otherwise, the fuel to the gas turbine contains about 60 to less than 100 percent hydrogen by volume.

In a thirty-first aspect of the present disclosure, which may be combined with any other aspect listed herein unless specified otherwise, the fuel to the gas turbine contains about 75 to 85 percent hydrogen by volume.

In a thirty-second aspect of the present disclosure, which may be combined with any other aspect listed herein unless specified otherwise, the LNG facility further comprises an acid gas removal unit configured to accept raw feed natural gas and to generate acid gas stream, a flash gas stream, and a purified natural gas stream.

In a thirty-third aspect of the present disclosure, which may be combined with any other aspect listed herein unless specified otherwise, the acid gas stream is directable to the sequestration compression unit.

In a thirty-fourth aspect of the present disclosure, which may be combined with any other aspect listed herein unless specified otherwise, the flash gas stream is directable to the sequestration compression unit and to the steam reformer for use as a feedstock to the reformer.

In a thirty-fifth aspect of the present disclosure, which may be combined with any other aspect listed herein unless specified otherwise, the LNG facility further comprises a fuel gas conditioning unit configured to direct fuel gas to the gas turbine. The flash gas stream is directable to the fuel gas conditioning unit for use as fuel for the gas turbine.

In a thirty-sixth aspect of the present disclosure, which may be combined with any other aspect listed herein unless specified otherwise, at least one of the post-combustion capture units include an amine absorber and liquid amine absorbent for absorbing CO2, the steam reformer generates excess steam, and the excess steam is directable to the at least one post-combustion capture unit to provide heat for regenerating the liquid amine absorbent.

In a thirty-seventh aspect of the present disclosure, which may be combined with any other aspect listed herein unless specified otherwise, the acid gas removal unit includes an amine absorber and liquid amine absorbent for absorbing CO2, the steam reformer generates excess steam, and the excess steam is directable to the acid gas removal unit to provide heat for regenerating the liquid amine absorbent.

In a thirty-eighth aspect of the present disclosure, which may be combined with any other aspect listed herein unless specified otherwise, the steam reformer generates excess steam, and where the excess steam is directable to drive a compressor.

In a thirty-ninth aspect of the present disclosure, which may be combined with any other aspect listed herein unless specified otherwise, the sequestration compression unit comprises a compressor driven by an electric motor.

In a fortieth aspect of the present disclosure, which may be combined with any other aspect listed herein unless specified otherwise, the sequestration compression unit comprises a compressor driven by a gas turbine.

In a forty-first aspect of the present disclosure, which may be combined with any other aspect listed herein unless specified otherwise, the sequestration compression unit comprises a compressor driven by a hydrogen turbine configured to be driven by excess hydrogen from the steam reformer.

In a forty-second aspect of the present disclosure, which may be combined with any other aspect listed herein unless specified otherwise, the LNG facility further comprises a heavies removal unit, a condensation storage tank, an LNG storage tank, and an LNG loading facility. The heavies removal unit is configured to receive the dry purified natural gas stream from the dehydration unit and to produce a liquid condensate product and a vapor product. The condensation storage tank is configured to receive the liquid condensate product from the heavies removal unit, and to allow for the venting of boil off gas (BOG). The LNG storage tank is configured to receive and store LNG from the liquefaction unit, and allow for the venting of BOG. The LNG loading facility is configured to receive LNG from the LNG storage tank and to transfer LNG to a marine vessel comprising a marine LNG storage tank. The LNG loading facility is further configured to allow for the venting of BOG. BOG from at least one of the condensation storage tank, the LNG storage tank, and the LNG loading facility is directable as feed to the steam reformer.

In a forty-third aspect of the present disclosure, which may be combined with any other aspect listed herein unless specified otherwise, BOG from each of the condensation storage tank, the LNG storage tank, and the LNG loading facility is directable as feed to the steam reformer.

In a forty-fourth aspect of the present disclosure, which may be combined with any other aspect listed herein unless specified otherwise, the LNG facility further comprises a marine vent system adapted to receive marine vessel tank gas from a marine LNG storage tank of a marine vessel, and to direct the marine vessel tank gas to feed any of: a post-combustion capture unit, a sequestration compression unit, a fuel gas conditioning unit, and a steam reformer. The marine vessel tank gas comprises BOG from LNG, CO, CO2, N2 or mixtures thereof.

In a forty-fifth aspect of the present disclosure, which may be combined with any other aspect listed herein unless specified otherwise, a process for manufacturing liquefied natural gas (LNG) in a LNG production facility comprises generating hydrogen using an on-site hydrogen generation unit, using at least of portion of hydrogen to provide a hydrogen-enriched hydrocarbon fuel to a gas turbine, and condensing natural gas vapor into liquefied nature gas in a liquefaction unit powered at least in part by the gas turbine.

In a forty-sixth aspect of the present disclosure, which may be combined with any other aspect listed herein unless specified otherwise, the hydrogen generation unit comprises a steam reformer.

In a forty-seventh aspect of the present disclosure, which may be combined with any other aspect listed herein unless specified otherwise, the process further comprises passing the combustion products from the gas turbine through a post-combustion capture unit to generate a CO2-rich stream.

In a forty-eighth aspect of the present disclosure, which may be combined with any other aspect listed herein unless specified otherwise, the process further comprises passing the products from the steam reformer through a post-combustion capture unit to generate a CO2-rich stream.

In a forty-ninth aspect of the present disclosure, which may be combined with any other aspect listed herein unless specified otherwise, the process further comprises compressing, at a sequestration compression unit, at least one CO2-rich stream from a post-combustion capture unit, and transferring the CO2-rich stream towards a sequestration site, thereby reducing the total emissions from the LNG facility.

In a fiftieth aspect of the present disclosure, which may be combined with any other aspect listed herein unless specified otherwise, the sequestration site comprises an underground geological formation comprising an at least partially depleted hydrocarbon reservoir.

In a fifty-first aspect of the present disclosure, which may be combined with any other aspect listed herein unless specified otherwise, the hydrocarbon reservoir is only partially depleted, and at least some of the transferred the CO2-rich stream is injected into the sequestration site to aid in enhanced oil recovery.

In a fifty-second aspect of the present disclosure, which may be combined with any other aspect listed herein unless specified otherwise, the process further comprises flowing raw feed natural gas to an acid gas removal unit, and thereby generating an acid gas stream, a flash gas stream, and a purified natural gas stream.

In a fifty-third aspect of the present disclosure, which may be combined with any other aspect listed herein unless specified otherwise, the process further comprises directing the acid gas stream to the sequestration compression unit.

In a fifty-fourth aspect of the present disclosure, which may be combined with any other aspect listed herein unless specified otherwise, the process further comprises directing the flash gas stream to the sequestration compression unit.

In a fifty-fifth aspect of the present disclosure, which may be combined with any other aspect listed herein unless specified otherwise, the process further comprises directing the flash gas stream to the steam reformer for use as a feedstock to the reformer.

In a fifty-sixth aspect of the present disclosure, which may be combined with any other aspect listed herein unless specified otherwise, the process further comprises directing the flash gas stream to a fuel gas conditioning unit for use as fuel for the gas turbine, where the fuel gas conditioning unit directs fuel gas to the gas turbine.

In a fifty-seventh aspect of the present disclosure, which may be combined with any other aspect listed herein unless specified otherwise, the raw feed natural gas is sourced from a natural gas pipeline.

In a fifty-eighth aspect of the present disclosure, which may be combined with any other aspect listed herein unless specified otherwise, the sequestration compression unit comprises a compressor driven by an electric motor.

In a fifty-ninth aspect of the present disclosure, which may be combined with any other aspect listed herein unless specified otherwise, the sequestration compression unit comprises a compressor driven by the gas turbine.

In a sixtieth aspect of the present disclosure, which may be combined with any other aspect listed herein unless specified otherwise, the sequestration compression unit comprises a compressor driven by a hydrogen turbine configured to use excess hydrogen from the steam reformer.

In a sixty-first aspect of the present disclosure, which may be combined with any other aspect listed herein unless specified otherwise, the post-combustion capture unit includes an amine absorber and liquid amine absorbent for absorbing CO2, the process further comprising generating excess steam in the steam reformer, and directing the excess steam to the post-combustion capture unit to provide heat for regenerating the liquid amine absorbent.

In a sixty-second aspect of the present disclosure, which may be combined with any other aspect listed herein unless specified otherwise, the acid gas removal unit includes an amine absorber and liquid amine absorbent for absorbing CO2, the process further comprising generating excess steam in the steam reformer, and directing the excess steam to the acid gas removal unit to provide heat for regenerating the liquid amine absorbent.

In a sixty-third aspect of the present disclosure, which may be combined with any other aspect listed herein unless specified otherwise, the process further comprises flowing the purified natural gas stream from the acid gas removal unit to a dehydration unit comprising a solid adsorbent, removing water vapor from the purified natural gas stream using the solid adsorbent to obtain a dry purified natural gas stream, generating excess steam in the steam reformer, and directing the excess steam to the dehydration unit to provide heat for regenerating the solid adsorbent.

In a sixty-fourth aspect of the present disclosure, which may be combined with any other aspect listed herein unless specified otherwise, the process further comprises generating excess steam in the steam reformer, and directing the excess steam to the sequestration unit, where the sequestration compression unit comprises a compressor driven by the excess steam from the steam reformer.

In a sixty-fifth aspect of the present disclosure, which may be combined with any other aspect listed herein unless specified otherwise, the process further comprises a heavies removal unit, a condensation storage tank, an LNG storage tank, and an LNG loading facility. The heavies removal unit is configured to receive the dry purified natural gas stream from the dehydration unit and produce a liquid condensate product and a vapor product. The condensation storage tank is configured to receive the liquid condensate product from the heavies removal unit, and allow for the venting of boil off gas (BOG). The LNG storage tank is configured to receive and store LNG from the liquefaction unit, and allow for the venting of BOG. The LNG loading facility is configured to receive LNG from the LNG storage tank and transfer LNG to a marine vessel comprising a marine LNG storage tank. The LNG loading facility is further configured to allow for the venting of BOG. The process further comprises directing the BOG from at least one of the condensation storage tank, the LNG storage tank, and the LNG loading facility as feed to the steam reformer.

In a sixty-sixth aspect of the present disclosure, which may be combined with any other aspect listed herein unless specified otherwise, the process further comprises directing the BOG from each of the condensation storage tank, the LNG storage tank, and the LNG loading facility as feed to the steam reformer.

In a sixty-seventh aspect of the present disclosure, which may be combined with any other aspect listed herein unless specified otherwise, the process further comprises a marine vent system adapted to receive marine vessel tank gas from a marine LNG storage tank of a marine vessel. The process further comprises directing the marine vessel tank gas to feed any of: a post-combustion capture unit, a sequestration compression unit, a fuel gas conditioning unit, and a steam reformer. The marine vessel tank gas comprises BOG from LNG, CO, CO2, N2 or mixtures thereof.

In a sixty-eighth aspect of the present disclosure, which may be combined with any other aspect listed herein unless specified otherwise, the sequestration site comprises a tank, wherein the tank is an on-site storage tank, a tank mounted on a rail car, or a tank mounted on a truck-drawn trailer.

In a sixty-ninth aspect of the present disclosure, which may be combined with any other aspect listed herein unless specified otherwise, a natural gas power generation facility comprises a gas turbine, an electric generator coupled to the gas turbine, and a hydrogen generation unit. At least a portion of hydrogen formed in the hydrogen generation unit is combusted, along with hydrocarbons, as fuel in the gas turbine.

Additional features and advantages of the disclosed devices, systems, and methods are described in, and will be apparent from, the following Detailed Description and the FIGURES. The features and advantages described herein are not all-inclusive and, in particular, many additional features and advantages will be apparent to one of ordinary skill in the art in view of the figures and description. Also, any particular embodiment does not have to have all of the advantages listed herein. Moreover, it should be noted that the language used in the specification has been principally selected for readability and instructional purposes, and not to limit the scope of the inventive subject matter.

### BRIEF DESCRIPTION OF THE FIGURES

Understanding that the FIGURES depict only typical embodiments of the invention and are not to be considered to be limiting the scope of the present disclosure, the present disclosure is described and explained with additional specificity and detail through the use of the accompanying FIGURES. The figures are listed below.

FIG. 1 illustrates an exemplary schematic of a liquefied natural gas production facility.

### DETAILED DESCRIPTION OF EXAMPLE EMBODIMENTS

Although the following text sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One of ordinary skill in the art could implement numerous alternate embodiments, which would still fall within the scope of the claims. Unless a term is expressly defined herein using the sentence “As used herein, the term ‘_’ is hereby defined to mean . . . ” or a similar sentence, there is no intent to limit the meaning of that term beyond its plain or ordinary meaning. To the extent that any term is referred to in this patent in a manner consistent with a single meaning, that is done for sake of clarity only, and it is not intended that such claim term be limited to that single meaning. Finally, unless a claim element is defined by reciting the word “means” and a function without the recital of any structure, it is not intended that the scope of any claim element be interpreted based on the application of 35 U.S.C. § 112(f).

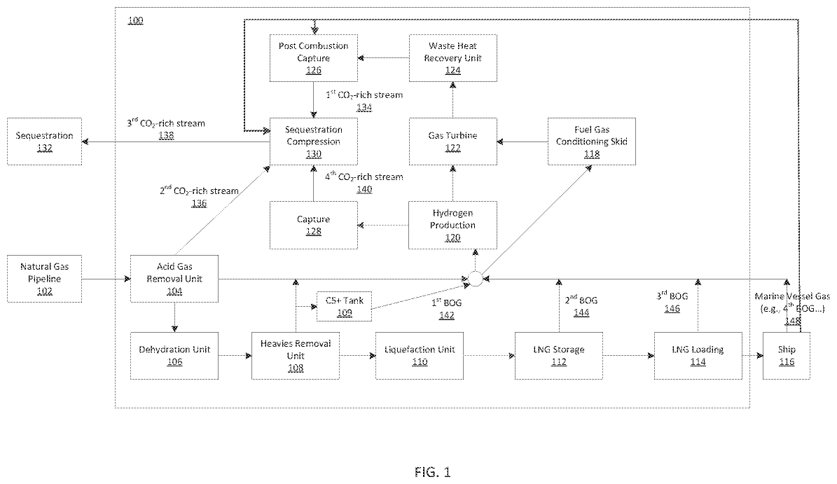

Referring now to the FIGURES, FIG. 1 illustrates an exemplary schematic of a liquefied natural gas production facility 100. The facility 100 receives raw feed gas, such as natural gas, from a pipeline 102 (e.g., a natural gas pipeline).

Once received, the natural gas is sent from the pipeline 102 to an acid gas removal unit 104 within facility 100. Acid gas removal unit 104 accepts this natural gas from pipeline 102, and generates one or more of an acid gas stream, a flash gas stream, and a purified natural gas stream.

More specifically, acid gas removal unit 104 advantageously processes the natural gas to remove various contaminants, such as mercury, hydrogen-sulfide, carbon dioxide, and the like. In a particular embodiment, the acid gas removal unit 104 treats incoming natural gas, in order to remove carbon dioxide from the natural gas stream. For example, acid gas removal unit 104 may implement an amine process, which absorbs the carbon dioxide in an amine absorber. In an embodiment, acid gas removal unit 104 includes an amine absorber and liquid amine absorbent for absorbing carbon dioxide. The amine is then heated (e.g., regenerated), to return to the absorber. The carbon dioxide rich stream (also referred to generally as an acid gas stream) is separated and sent directly to sequestration compression 130, described in greater detail herein. Advantageously, this acid gas stream is not sent to a thermal oxidizer; thus, the acid gas stream need not be combusted and released into the atmosphere via any thermal oxidation process. Similarly, acid gas removal unit 104 directs the flash gas stream to at least one of sequestration compression 130, fuel gas conditioning skid 118, and hydrogen production 120. When flash gas is sent to fuel gas conditioning skid 118, it can advantageously be used as fuel for the gas turbine 122; namely, fuel gas conditioning skid 118 may direct fuel gas to the gas turbine 122. When flash gas is sent to hydrogen production 120, it can advantageously be used by a steam reformer as feedstock for the reformer.

Upon processing by acid gas removal unit 104, the purified natural gas stream, with the carbon dioxide removed, is sent to dehydration unit 106.

More specifically, treated gas is then sent to a dehydration unit 106, which removes water from the gas. As illustrated by FIG. 1, the dehydration unit 106 is located downstream of the acid gas removal unit 104. Thus, because the amine solution of the acid gas removal unit 104 saturates the exiting feed gas with water, this water is removed in the dehydration unit 106. In an embodiment, dehydration unit 106 reduces water content of feed gas to less than 0.5 ppmv, to prevent water freeze out in the downstream cryogenic processing within facility 100.

Dehydration unit 106 may include a solid adsorbent. In an embodiment, the dehydration unit 106 is based on a three-bed molecular sieve bed configuration: two beds operating in water adsorption mode, while the third bed is being regenerated. During the adsorption process, the vapor is cooled, exits a drier feed gas filter coalescer, and passes downward through regenerated molecular sieve driers. Each externally insulated absorber vessel contains 4 A molecular sieve adsorbent, to remove water. During the regeneration process, a slip stream of product gas (dried gas) is used for regeneration. The regeneration gas passes through a drier regeneration gas compressor and a flow control valve, before it enters the regeneration gas heat exchanger, which raises the gas temperature to 550° F. The dehydration regeneration gas is heated with hot oil. In an embodiment, the hot oil is heated from the waste heat recovery units, such as waste heat recovery unit 124 described in greater detail herein.

The gas, as a dry purified natural gas stream, is next sent to a heavies removal unit 108. In an embodiment, heavies removal unit 108 is configured to receive the dry purified natural gas stream from the dehydration unit 106 and subsequently produce both a liquid condensate product and a vapor product. Specifically, heavies removal unit 108 separates condensate from gas, and sends condensate to a condensate storage tank 109. Generally, the purpose of the heavies removal unit 106 is to remove enough C5 and heavier components (including benzene) from the natural gas stream that has left the dehydration unit 106 to meet the liquid natural gas (LNG) product specification and avoid the undesirable freezing of these components during liquefaction. In an embodiment, heavies removal unit 108 includes a series of pumps, exchangers, towers, compressors, and other related processing equipment, for separating heavy components.

The heavy components (e.g., liquid condensate product) are sent to a condensate storage tank, such as C5+ tank 109. Some of this condensate will boil off, producing condensate boil off gas. This boil off gas may be sent to at least one of fuel gas conditioning skid 118 and hydrogen production 120, as disclosed in greater detail herein. Advantageously, the boil off gas is not sent to a thermal oxidizer or other flare; thus, the boil off gas is not combusted and released into the atmosphere via any thermal oxidation process.

After processing at the heavies removal unit 108, the gas is sent to a liquefaction unit 110. In an embodiment, liquefaction unit 110 is one or more refrigeration units, compressors, and/or heat exchangers, which convert the gas into LNG via cooling and condensation. For example, the temperature of the gas is lowered to approximately −260° F., thus necessitating a phase change from gas to LNG. In an embodiment, the main refrigeration compressor(s) for liquefaction unit 110 is driven by either a natural gas fired turbine or an electric motor. For example, liquefaction unit 110 may be powered, at least in part, via gas turbine 122.

LNG is then sent to LNG storage 112. In an embodiment, LNG storage 112 is one or more storage tanks, such as double walled tanks, which are transportable. Once in a stored-state, LNG is constantly boiling off, producing additional boil off gas, which may be sent to at least one of fuel gas conditioning skid 118 and hydrogen production 120, as disclosed in greater detail herein. Additionally or alternatively, boil off gas can be recompressed and sent back to the liquefaction unit 110.

Via LNG loading infrastructure 114, LNG is pumped out of the LNG storage tanks 112 and loaded into LNG vessels 116, via loading arms, cranes, forklifts, and other transportation means. In an particular embodiment, LNG vessel 116 is a seafaring ship with marine LNG storage tanks. Loading onto a ship typically produces additional boil off gas, which may be sent to at least one of fuel gas conditioning skid 118 and hydrogen production 120, as disclosed in greater detail herein. Advantageously, the boil off gas is not sent to a thermal oxidizer or other flare such as a marine flare. Facility 100 may further include a marine vent system, adapted to receive gas from a marine LNG storage tank on a vessel 116, and subsequently direct this ship vessel gas (e.g., boil off gas from LNG, carbon monoxide, carbon dioxide, nitrogen, or mixtures thereof) to any of post combustion capture facility 126, post combustion capture facility 128, sequestration compression 130, fuel gas conditioning skid 118, and hydrogen production 120 as appropriate.

As previously noted above, boil off gas is sent from one or more of acid gas removal unit 104, heavies removal unit 108, LNG storage 112, LNG loading 114, and ship 116 to one of at least fuel gas conditioning skid 118 and hydrogen production 120.

Fuel gas conditioning skid 118 takes streams of natural gas, such as boil off gasses, and adjusts various physical conditions (e.g., temperatures, pressures, blends, and the like) to ensure that the gasses are configured for optimal combustion in a gas turbine 122. In an embodiment, fuel gas conditioning skid 118 directs fuel gas to gas turbine 122. As previously noted, flash gas stream is directable to fuel gas conditioning skid 118 for use as fuel for gas turbine 122.

Advantageously, facility 100 further includes hydrogen production 120. In an embodiment, hydrogen production 120 is a steam reformer, such as a methane gas reformer, which is configured to generate hydrogen on-site. It should be appreciated that, in additional or alternative embodiments, hydrogen production 120 could be produced via other means, such as via an electrolysis unit whereby water is split into hydrogen and oxygen through the use of electricity. Likewise, it should be appreciated that, in additional or alternative embodiments, hydrogen production 120 could be offsite, such as via an offsite supply of hydrogen, whereby hydrogen may come into the LNG facility via pipeline, railcar, ship or other convenient means.

With that in mind, hydrogen production 120, such as via the steam reformer, allows for high temperature steam to react with methane, in the presence of a catalyst, to produce hydrogen, carbon monoxide, and carbon dioxide. With reference to FIG. 1, it should be appreciated that boil off gas from each of condensation storage tank 109, LNG storage 112, and LNG loading 114 are directable as feed to hydrogen production 120. Additional processes can be incorporated with hydrogen production 120, such as a water-gas shift reaction and/or pressure swing adsorption, to increase the yield of hydrogen.

Hydrogen may be provided to gas turbine 122 as fuel, for optimal combustion. For example, the fuel provided to gas turbine 122 may be a hydrogen-enriched hydrocarbon fuel. In an embodiment, fuel provided to gas turbine 122 contains at least 10 percent hydrogen by volume. In a preferred embodiment, fuel provided to gas turbine 122 contains about 60 to less than 100 percent hydrogen by volume. In a more preferred embodiment, fuel provided to gas turbine 122 contains about 75 to 85 percent hydrogen by volume. Excess hydrogen may be generated on-site from the steam reformer. Such hydrogen may be stored in an on-site storage tank, and may be sent off-site for consumption by others, for example, by way of pipeline, railcar, or truck-drawn trailer.

In an embodiment, facility 100 further includes one or more electric generators, whereby gas turbine 122 is coupled to the one or more electric generators; in this embodiment, facility 100 may further serve as a natural gas power generation facility.

In an embodiment, hydrogen production 120 generates excess steam, which is directable to acid gas removal unit 104; this excess steam provides heat to acid gas removal unit 104 for regenerating liquid amine absorbent. In an embodiment, hydrogen production 120 generates excess steam, which is directable to dehydration unit 106; this excess steam provides heat to dehydration unit 106 for regenerating solid adsorbent. In an embodiment, hydrogen production unit 120 generates excess steam, which is directable to drive a compressor. In a related embodiment, hydrogen production 120 generates excess steam, which is directable to sequestration compression 130; this excess steam drives a compressor at sequestration compression 130.

Once combusted, gas from the gas turbine 122 may pass to a waste heat recovery unit 124. The waste heat recovery unit 124 uses heat generated by a combustion process, such as via combustion in gas turbine 122, to heat up a heat medium (e.g., hot oil or steam). The heated medium is then used in various processes throughout facility 100 where additional heat is required (e.g., amine regeneration, dehydration regeneration, and the like).

For example, the waste heat recovery unit 124 may advantageously communicate with one or more of acid gas removal unit 104, dehydration unit 106, and heavies removal unit 108, to provide heat to these components. In an embodiment, waste heat recovery unit 124 communicates with a cogeneration unit (not illustrated), which uses the waste heat from gas turbine 122 to generate steam that, in turn, rotates a generator to produce electricity. The electricity can then be used in other parts of the facility 100 or, alternatively, be sent to the electric grid.

After heat has been recovered at waste heat recovery unit 124, gas passes to post combustion capture facility 126. In an embodiment, post combustion capture facility 126 generates a carbon dioxide rich stream from the combustion products derived from the gas turbine 122. Specifically, post combustion capture facility 126 captures the products of combustion, for example, using an amine process to absorb carbon dioxide from the flue gas stream. Specifically, it should be appreciated that there are different types of amine depending on the relative concentrations of carbon dioxide in the flue gas stream. Natural gas fired turbines typically produce a relatively less concentrated carbon dioxide stream (e.g., approximately less than 5%) as compared to a natural gas steam methane reformer 120 (e.g., approximately 25%) and thus would generally use a different mixture to absorb the carbon dioxide. Other processes can additionally or alternatively include use of ammonia or other related materials.

Similar to gas passing from waste heat recovery unit 124 to post combustion capture facility 126, it should be appreciated that gas from hydrogen production 120 may pass directly to post combustion capture facility 128 (or the same facility 126) and be processed as described above. Namely, post combustion capture facility 128 generates a carbon dioxide rich stream from the products of hydrogen production 120.

In an embodiment, post combustion capture facility 126 includes an amine absorber and liquid amine absorbent for absorbing carbon dioxide. In a related embodiment, hydrogen production 120 generates excess steam, which is directable to post combustion capture facility 126; this excess steam provides heat to post combustion capture facility for regenerating the liquid amine absorbent.

After post combustion capture, gas passes to sequestration compression unit 130. More specifically, sequestration compression unit 130 includes one or more knockout drums for collecting any remaining liquid in the gas stream. Sequestration compression unit 130 further includes at least one compressor, configured to compress the carbon dioxide rich stream, which may be then sent to a pipeline for off-site sequestration 132. By sending the carbon dioxide rich stream to some form of sequestration, overall greenhouse gas emissions from facility 100 are reduced. Other forms of sequestration (not shown in FIG. 1) may be implemented, including for example sending the CO2 rich gas to an on-site or off-site storage tank, to a tank mounted on a rail car, or a tank mounted on a truck-drawn trailer. After compression, the sequestered CO2 rich gas may advantageously be sold for a number of well-known applications and uses.

In an embodiment, sequestration compression unit 130 includes a compressor that is driven by steam generated from a steam reformer during hydrogen production 120. In a related embodiment, the compressor is driven by a hydrogen turbine configured to be driven by excess hydrogen, derived from the steam reformer during hydrogen production 120. In another embodiment, sequestration compression unit 130 includes a compressor that is driven by gas turbine 122. In yet another embodiment, sequestration compression unit 130 includes a compressor that is driven by an electric motor. Liquids from the knockout drums within sequestration compression unit 130 are sent back to C5+ storage tank 109.

As previously noted, sequestration compression unit 130 sends the carbon dioxide rich stream away from facility 100 for off-site sequestration 132. In an embodiment, sequestration 132 is an underground geological formation that includes at least a partially depleted hydrocarbon reservoir. In a related embodiment, at least some of the transferred carbon dioxide rich stream is injectable into the hydrocarbon reservoir, to aid in enhanced oil recovery.

As used in this specification, including the claims, the term “and/or” is a conjunction that is either inclusive or exclusive. Accordingly, the term “and/or” either signifies the presence of two or more things in a group or signifies that one selection may be made from a group of alternatives.

The many features and advantages of the present disclosure are apparent from the written description, and thus, the appended claims are intended to cover all such features and advantages of the disclosure. Further, since numerous modifications and changes will readily occur to those skilled in the art, the present disclosure is not limited to the exact construction and operation as illustrated and described. Therefore, the described embodiments should be taken as illustrative and not restrictive, and the disclosure should not be limited to the details given herein but should be defined by the following claims and their full scope of equivalents, whether foreseeable or unforeseeable now or in the future.

1. A liquefied natural gas (LNG) production facility comprising:
an acid gas removal unit configured to accept a raw feed natural gas and generate an acid gas stream, a flash gas stream, and a purified natural gas stream;
a dehydration unit including a solid adsorbent, the dehydration unit configured to receive the purified natural gas stream from the acid gas removal unit and provide a dry purified natural gas stream;
a heavies removal unit configured to receive the dry purified natural gas stream from the dehydration unit and produce a liquid condensate product and a vapor product;
a condensation storage tank configured to receive the liquid condensate product from the heavies removal unit and further configured for venting of a first boil off gas (BOG);
a liquefaction unit configured to condense the vapor product from the heavies removal unit into an LNG;
an LNG storage tank configured to receive and store the LNG from the liquefaction unit and further configured for venting of a second BOG;
an LNG loading facility configured to receive the LNG from the LNG storage tank and transfer the LNG to a marine vessel comprising a marine LNG storage tank, and the LNG loading facility further configured for venting of a third BOG;
a gas turbine;
a fuel gas conditioning unit configured to receive at least one of the first BOG, the second BOG, the third BOG, or the flash gas stream and direct a fuel gas to the gas turbine;
at least one post-combustion capture unit configured to generate a first carbon dioxide (CO₂)-rich stream from a combustion product of the gas turbine; and
a sequestration compression unit configured to compress a CO₂-rich stream into a third CO₂-rich stream, the CO₂-rich stream is selected from the group consisting of the first CO₂-rich stream, a second CO₂-rich stream, and mixtures thereof, and the second CO₂-rich stream is selected from the group consisting of the acid gas stream from the acid gas removal unit, the flash gas stream from the acid gas removal unit, and mixtures thereof, and
the sequestration compression unit further configured to convey the third CO₂-rich stream towards a sequestration site.

2-3. (canceled)

4. The LNG production facility of claim 1, wherein the at least one post-combustion capture unit includes an amine absorber and a liquid amine absorbent for absorbing CO₂.

5. The LNG production facility of claim 1, wherein the acid gas removal unit includes an amine absorber and a liquid amine absorbent for absorbing CO₂.

6. (canceled)

7. The LNG production facility of claim 1 further comprising a marine vent system adapted to receive the marine vessel tank gas from the marine LNG storage tank of the marine vessel, and the marine vent system further adapted to direct a marine vessel gas from the marine vessel to feed any of:
the at least one post-combustion capture unit;
the sequestration compression unit; or
the fuel gas conditioning unit;
wherein the marine vessel gas is selected from the group consisting of carbon monoxide (CO), CO₂, nitrogen (N2), a fourth BOG from an LNG from the marine LNG storage tank, and mixtures thereof.

8. The LNG production facility of claim 1 further comprising:
a hydrogen generation unit including a steam reformer configured to generate a product comprising hydrogen,
wherein at least a portion of the hydrogen is combusted in the gas turbine.

9. The LNG production facility of claim 8, wherein the fuel gas to the gas turbine contains about 75 to 85 percent hydrogen by volume.

10. The LNG production facility of claim 9 further comprising at least one capture unit configured to generate a third CO2-rich stream from the product of the steam reformer.

11. The LNG production facility of claim 1, wherein the sequestration compression unit comprises a compressor driven by an electric motor.

12. The LNG production facility of claim 1, wherein the sequestration compression unit comprises a compressor driven by the gas turbine.

13. The LNG production facility of claim 1, wherein the sequestration site comprises an underground geological formation comprising an at least partially depleted hydrocarbon reservoir.

14. The LNG production facility of claim 1, wherein the sequestration site comprises a tank, wherein the tank is an on-site storage tank, a tank mounted on a rail car, or a tank mounted on a truck-drawn trailer.

15. A liquefied natural gas (LNG) production facility comprising:
an acid gas removal unit configured to accept a raw feed natural gas and generate an acid gas stream, a flash gas stream, and a purified natural gas stream;
a dehydration unit including a solid adsorbent, the dehydration unit configured to receive the purified natural gas stream from the acid gas removal unit and provide a dry purified natural gas stream;
a heavies removal unit configured to receive the dry purified natural gas stream from the dehydration unit and produce a liquid condensate product and a vapor product;
a condensation storage tank configured to receive the liquid condensate product from the heavies removal unit and further configured for venting of a first boil off gas (BOG);
a liquefaction unit configured to condense the vapor product from the heavies removal unit into an LNG;
an LNG storage tank configured to receive and store the LNG from the liquefaction unit and further configured for venting of a second BOG;
an LNG loading facility configured to receive the LNG from the LNG storage tank and transfer the LNG to a marine vessel comprising a marine LNG storage tank, and the LNG loading facility further configured for venting of a third BOG;
a gas turbine configured to combust a hydrocarbon fuel to produce a combustion product;
at least one post-combustion capture unit configured to generate a first carbon dioxide (CO₂)-rich stream from the combustion product of the gas turbine; and
a sequestration compression unit configured to compress a CO₂-rich stream into a third CO₂-rich stream, the CO₂-rich stream is selected from the group consisting of the first CO₂-rich stream, a second CO₂-rich stream, and mixtures thereof, and the second CO₂-rich stream is selected from the group consisting of the acid gas stream from the acid gas removal unit, the flash gas stream from the acid gas removal unit, and mixtures thereof, and
the sequestration compression unit further configured to transport the third CO₂-rich stream towards an off-site sequestration reservoir.

16. (canceled)

17. The LNG production facility of claim 15, wherein the at least one post-combustion capture unit comprises an amine absorber and a liquid amine absorbent for absorbing CO₂.

18. The LNG production facility of claim 15, wherein the acid gas removal unit includes an amine absorber and a liquid amine absorbent for absorbing CO₂.

19. (canceled)

20. The LNG production facility of claim 15 further comprising a marine vent system adapted to receive a marine vessel tank gas from the marine LNG storage tank of the marine vessel, and the marine vent system further adapted to direct a marine vessel gas to feed any of:
the at least one post-combustion capture unit;
the sequestration compression unit; or
a fuel gas conditioning unit;
wherein the marine vessel gas is selected from the group consisting of carbon monoxide (CO), CO₂, nitrogen (N2), a fourth BOG from an LNG from the marine LNG storage tank, and mixtures thereof.

21. The LNG production facility of claim 15, wherein the hydrocarbon fuel comprises at least 10 percent hydrogen by volume, and the LNG production facility further comprises an on-site hydrogen generation unit configured to provide the hydrogen to the gas turbine, the on-site hydrocarbon generation unit comprising a methane gas reformer.

22. A liquefied natural gas (LNG) facility comprising:
an acid gas removal unit configured to accept a raw feed natural gas and generate an acid gas stream, a flash gas stream, and a purified natural gas stream;
a dehydration unit including a solid adsorbent, the dehydration unit configured to receive the purified natural gas stream from the acid gas removal unit and provide a dry purified natural gas stream;
a heavies removal unit configured to receive the dry purified natural gas stream from the dehydration unit and produce a liquid condensate product and a vapor product;
a condensation storage tank configured to receive the liquid condensate product from the heavies removal unit and further configured for venting of a first boil off gas (BOG);
a liquefaction unit configured to condense the vapor product from the heavies removal unit into an LNG;
a gas turbine;
at least one post-combustion capture unit configured to generate a first carbon dioxide (CO₂)-rich stream from a combustion product of the gas turbine; and
a sequestration compression unit configured to compress a CO₂-rich stream into a third CO₂-rich stream, the CO₂-rich stream is selected from the group consisting of the first CO₂-rich stream, a second CO₂-rich stream, and mixtures thereof, and the second CO₂-rich stream is selected from the group consisting of the acid gas stream from the acid gas removal unit, the flash gas stream from the acid gas removal unit, and mixtures thereof, and
the sequestration compression unit configured to convey the third CO₂-rich stream towards a sequestration site; and
a marine vent system adapted to receive a marine vessel tank gas from a marine LNG storage tank of a marine vessel, and the marine vent system further adapted to direct the marine vessel tank gas to feed any of:
the at least one post-combustion capture unit;
the sequestration compression unit; or
a fuel gas conditioning unit configured to receive the first BOG and provide a fuel for the gas turbine.

23. (canceled)

24. The LNG facility of claim 22, wherein the fuel gas conditioning unit is configured to receive the flash gas stream.

25-29. (canceled)

30. The LNG production facility of claim 8 further comprising at least one capture unit configured to generate a fourth CO₂-rich stream from the product of the steam reformer, wherein the LNG production facility is configured to direct the fourth CO₂-rich stream to the sequestration compression unit.

31. The LNG production facility of claim 15, wherein the sequestration compression unit comprises a compressor driven by an electric motor.

32. The LNG production facility of claim 15, wherein the sequestration site comprises an underground geological formation comprising an at least partially depleted hydrocarbon reservoir.

33. The LNG facility of claim 22, wherein the sequestration compression unit comprises a compressor driven by an electric motor.

34. The LNG facility of claim 22, wherein the sequestration site comprises an underground geological formation comprising an at least partially depleted hydrocarbon reservoir.
